(19) United States
(12) Patent Application Publication
(10) Pub. No.: US 2010/0151884 A1
(43) Pub. Date: Jun. 17, 2010

(54) Method for Monitoring a Smart Phone and Related Apparatus and System

(76) Inventors: Chih-Sung Chang, Taipei Hsien (TW); Shao-Fong Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/435,373

(22) Filed: May 4, 2009

(30) Foreign Application Priority Data
Dec. 11, 2008 (TW) 097148210

(51) Int. Cl. H04W 24/00

(52) U.S. Cl. 455/456.2

(57) ABSTRACT

A method for monitoring a smart phone includes triggering a network connection function, connecting to a server device via the network connection function to receive an indication signal indicating a lost status of the smart phone, and returning information of the smart phone to the server device via the network connection function when the indication signal indicates that the smart phone is lost.

### BACKGROUND OF THE INVENTION

1. Field of the Invention

The present invention relates to a method for monitoring a smart phone and related apparatus and system, and particularly, to a method and related apparatus and system capable of returning information of the smart phone automatically for a user to ascertain a location of the smart phone, so as to take related actions for decreasing lost risk.

2. Description of the Prior Art

With advancements in multimedia technology, a smart phone comprises powerful functions, such as wireless internet access, global positioning, photographing, media play, etc.; hence, the price goes up. Under such circumstances, losing the smart phone may cause a great loss.

Therefore, to improve the above-mentioned problems, the prior art has disclosed a software installed in the smart phone with operations as follows. After a user purchases a smart phone, the user has to send related information, such as International Mobile Equipment Identity (IMEI), International Mobile Subscriber Identity (IMSI), etc., to a database server. If a Subscriber Identity Module (SIM) card of the smart phone is replaced, the software will send IMSI of a new SIM card to a default phone number set by the original user via a short message. However, though the software can inform the owner of the lost situation, the software cannot perform the reporting operations without a SIM card inserted, causing that a thief can still use functions other than mobile communication. Besides, the software can be removed by program uninstallation; thus, it cannot prevent a thief from using the smart phone.

Therefore, how to raise the opportunity of finding back a lost multi-function smart phone has become a goal in the industry.

### SUMMARY OF THE INVENTION

It is therefore a primary objective of the claimed invention to provide a method for monitoring a smart phone and related apparatus and system.

The present invention discloses a method for monitoring a smart phone, which comprises triggering a network connection function, connecting to a server device via the network connection function to receive an indication signal indicating a lost status of the smart phone, and returning information of the smart phone to the server device via the network connection function when the indication signal indicates that the smart phone is lost.

The present invention further discloses a system, which comprises a server device for generating an indication signal according to a user message and a smart phone. The smart phone comprises an operating circuit for executing functions of the smart phone and a monitoring device. The monitoring device comprises a triggering unit for triggering a network connection function of the operating circuit, a connecting unit for connecting to the server device, to receive the indication signal via the network connection function, and a reporting unit for returning information of the smart phone to the server device via the network connection function when the indication indicates that the smart phone is lost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a flow chart according to an embodiment of the present invention.

FIG. 2 is a schematic diagram of a smart phone according to an embodiment of the present invention.

FIG. 3 to FIG. 6 are schematic diagrams of operations of a monitoring software in FIG. 2.

### DETAILED DESCRIPTION

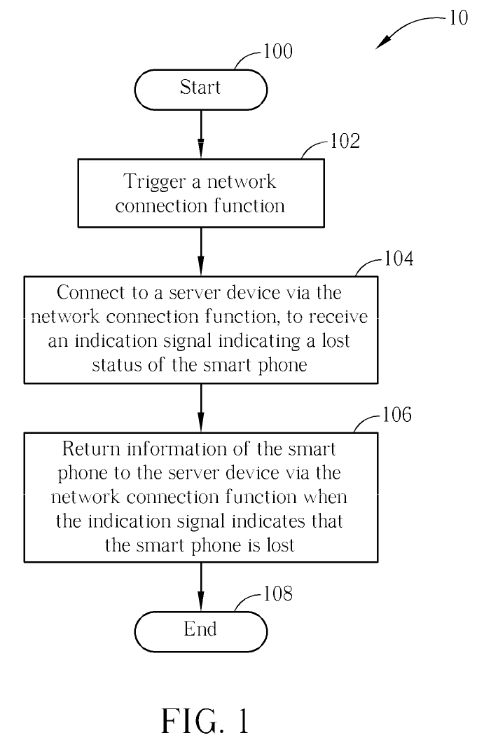

Please refer to FIG. 1, which illustrates a schematic diagram of a process 10 according to an embodiment of the present invention. The process 10 is utilized for decreasing lost risk of a smart phone, and comprises the following steps:

Step 100: Start.

Step 102: Trigger a network connection function.

Step 104: Connect to a server device via the network connection function, to receive an indication signal indicating a lost status of the smart phone.

Step 106: Return information of the smart phone to the server device via the network connection function when the indication signal indicates that the smart phone is lost.

Step 108: End.

According to the process 10, the present invention triggers the network connection function of the smart phone automatically, and connects to the server device, to receive the indication signal indicating the lost status of the smart phone. Next, if the indication signal indicates that the smart phone is lost, the present invention returns information of the smart phone to the server device via the triggered network connection function. In brief, via the present invention, the smart phone can automatically trigger the network connection function, to receive the indication signal generated by the server device, so as to return the information of the smart phone to the server device accordingly. Under such circumstances, when the smart phone is lost, a user can inform or set the server device to generate the related indication signal at first. Then, when the smart phone can connect to the network, the smart phone outputs related information to the server device. Therefore, the user can ascertain the location of the smart phone and take related actions according to the information received by the server device.

Via the process 10, the smart phone can automatically connect to the network and timely return related information to the server device, to allow the user having better chances to find out the lost smart phone, as well as decrease lost risk. Note that, the process 10 is an embodiment of the present invention, and those skilled in the art can make modifications and alterations according to different requirements. For example, in order to save power or system resources, step 102 can trigger the network connection function only when a Subscriber Identity Module (SIM) card of the smart phone is replaced or removed. In addiction, the network connection function is not limited to a specific type; for example, the smart phone can access network connection function of a computer system via a connection interface (e.g. ActiveSync), or trigger wireless network connection function if possible. Meanwhile, the information of the smart phone returned to the server device can be International Mobile Equipment Identity (IMEI), International Mobile Subscriber Identity (IMSI), Cell Global Identity (GCI), or other information generated according to different conditions. For example, if the smart phone is equipped with a Global Positioning System (GPS) receiver, the smart phone can receive the location information by triggering the GPS receiver, and return the location information to the server device. If the smart phone is equipped with a camera, the present invention can trigger the camera to receive an image information, and return the image information to the server device. Certainly, the information of the smart phone returned is not limited to what mentioned above, other information, such as GPS track, media data, file, internet address, etc., can also be returned to the server device.

Besides, when the network connection function cannot be triggered for a predefined duration, the present invention can further stop operations of the smart phone and generate an indication message asking for a monitoring password. In other words, if the smart phone is not connected to the connection network after stolen, the thief still cannot use the smart phone. The monitoring password, the server device address and so on can be established by the user in advance.

Therefore, via the process 10, when the smart phone is lost, the user can ascertain the location of the smart phone and take related actions for decreasing lost risk according to the information received by the server device.

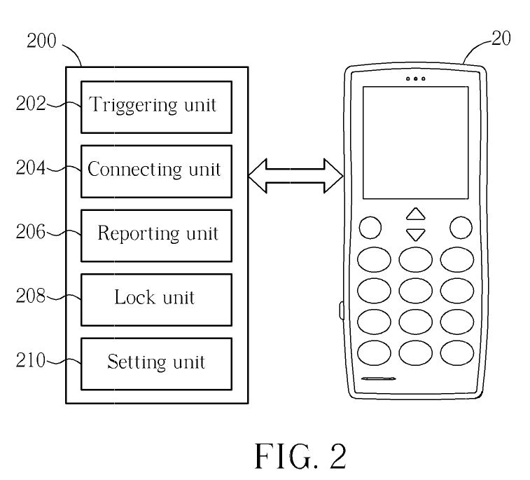

The process 10 can be implemented via software or hardware. For example, please refer to FIG. 2, which is a schematic diagram of a smart phone 20 according to an embodiment of the present invention. Functions of the smart phone 20 are implemented by an operating circuit (not shown in FIG. 2), and comprises a monitoring software 200 for decreasing lost risk. The monitoring software 200 comprises a triggering unit 202, a connecting unit 204, a reporting unit 206, a lock unit 208, and a setting unit 210. The triggering unit 202 is utilized for triggering a network connection function of the smart phone 20. The connecting unit 204 is utilized for connecting to a server device via the network connection function to receive an indication signal. The reporting unit 206 is utilized for returning information of the smart phone 20 to the server device via the network connection function when the indication signal indicates that the smart phone 20 is lost. The lock unit 208 is utilized for stopping operations of the smart phone 20 and generating an indication message asking for a password when the triggering unit 202 is incapable of triggering the network connection function for a predefined duration. The setting unit 210 is utilized for setting up a network address or a password of the server device by the user in advance.

The monitoring software 200 is utilized for implementing the process 10, detailed description thereof can be found in the above, and is not narrated further. The operations of the monitoring software 200 are as follows.

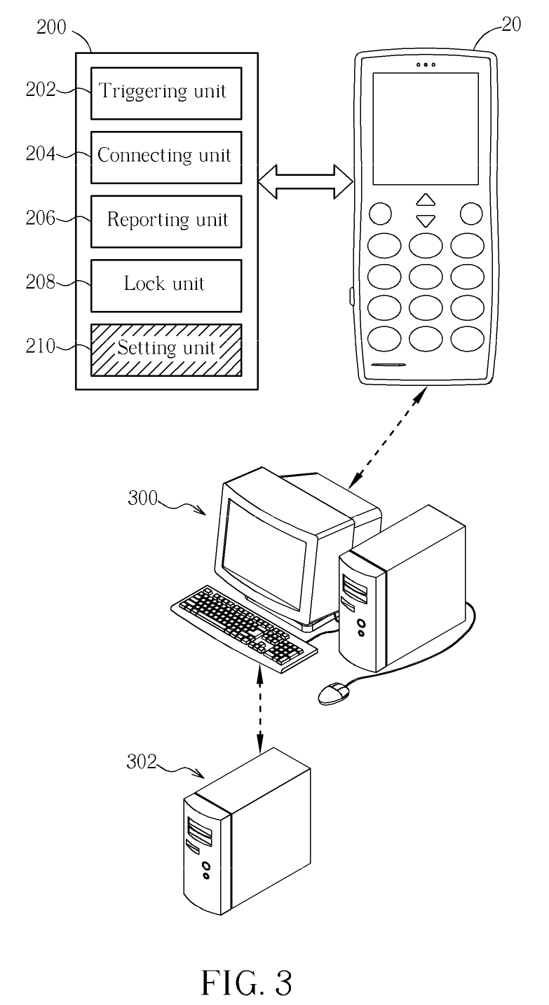

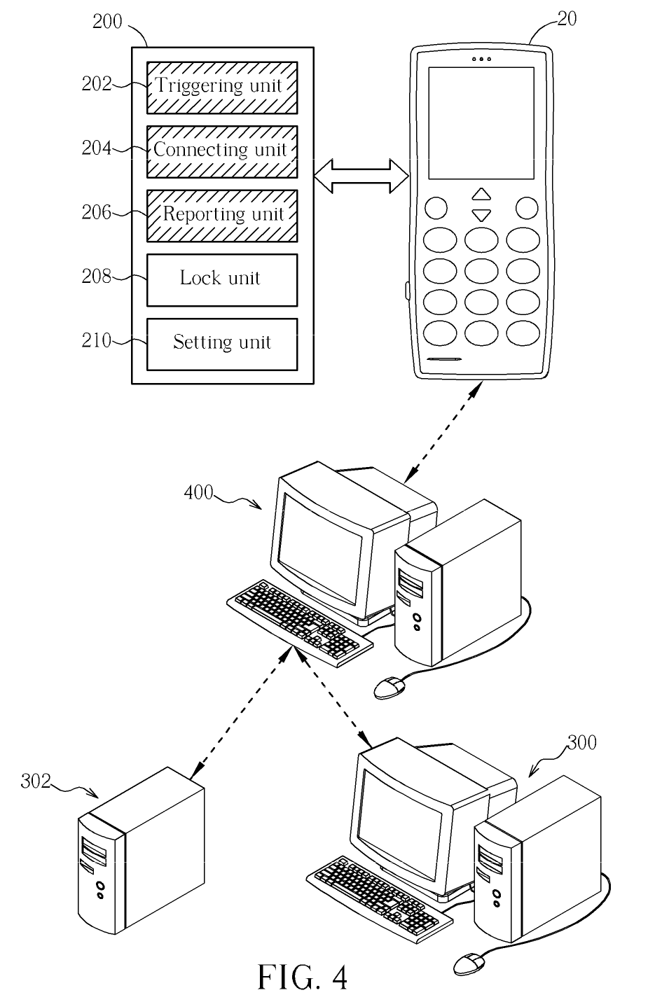

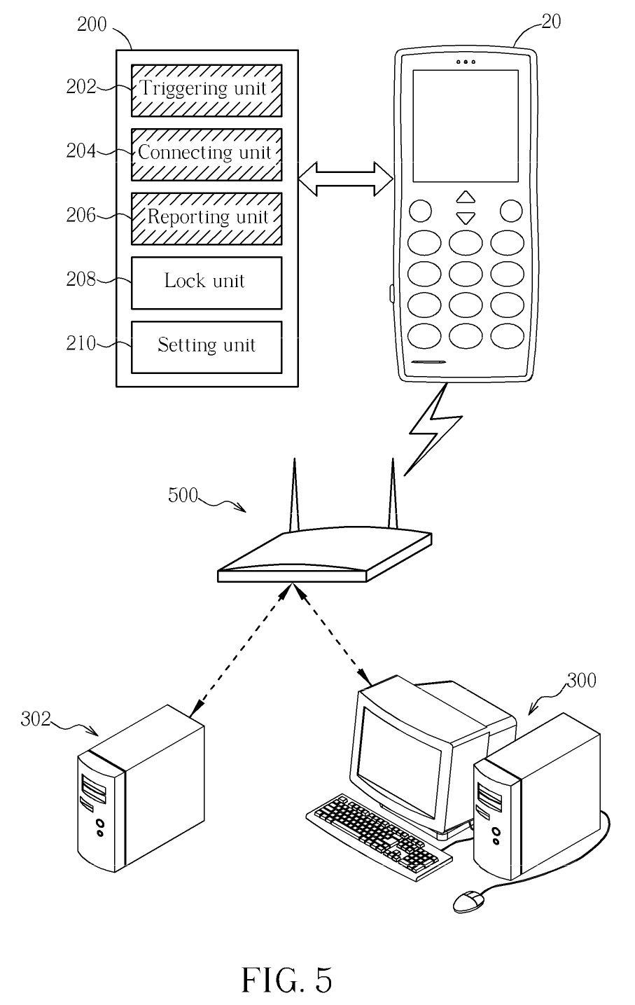

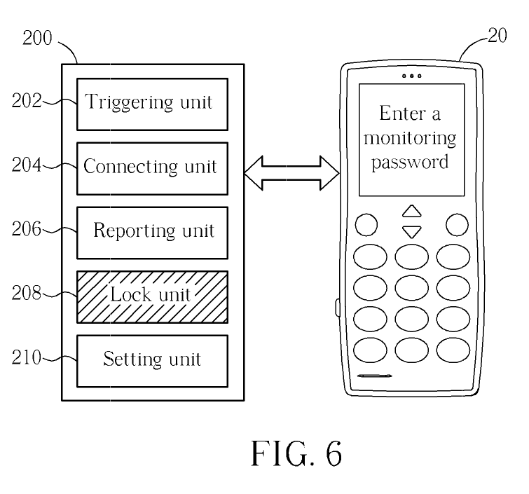

Please refer to FIG. 3. to FIG. 6, which are schematic diagrams illustrating operations of the monitoring software 200. In FIG. 3, after the user purchases the smart phone 20, the user should connect the smart phone 20 to a user computer 300, and set up information (e.g. network address) of the user computer 300 or a monitoring database 302 or related password via the setting unit 210. The user computer 300 or the monitoring database 302 can be the server device as mentioned above, which generates the indication signal indicating a lost status of the smart phone 20 according to a user message. Next, the triggering unit 202 can trigger the network connection function automatically or trigger the network connection function only when the SIM card is replaced or removed. Meanwhile, the triggered network connection function is not limited to any specific type. For instance, in FIG. 4, the smart phone 20 can connect to a computer system 400 via a connection interface (e.g. ActiveSync), so the triggering unit 202 can trigger the network connection function provided by the computer system 400. Or, as shown in FIG. 5, the smart phone 20 can build a wireless connection with a wireless base station 500, so the triggering unit 202 can trigger the wireless network connection function provided by the wireless base station 500. When the triggering unit 202 triggers the network connection function, the connecting unit 204 can connect to the user computer 300 or the monitoring database 302 to receive related indication signal. If the indication signal indicates that the smart phone 20 is lost, the reporting unit 206 can return related information to the user computer 300 or the monitoring database 302, such that the user can ascertain the location of the smart phone 20 and take related actions for decreasing lost risk. Certainly, as mentioned above, the information returned by the reporting unit 206 can be IMEI, IMSI, CGI, or other information generated according to different conditions, such as GPS information, image information, GPS track, media data, file, internet address and so on.

Besides, in FIG. 6, if the user does not connect to the network for a predefined duration, the lock unit 208 can generate an indication message (e.g. “enter a monitoring password”) and locks function of the smart phone 20.

Therefore, when the smart phone 20 is lost, the user can inform the server device, the user computer 300 or the monitoring database 302, to report the lost smart phone 20. Under such circumstances, when the smart phone 20 connects to the network, the monitoring software 200 will receive an indication signal generated by the server device, notifying that the smart phone 20 is lost, and return related information to the server device. Consequently, the user can ascertain the location of the smart phone 20 and take related actions according to the information received by the server device. On the contrary, if the smart phone 20 cannot connect to the network for a predefined duration, the monitoring software 200 can lock the smart phone 20, to prevent the theft from using the smart phone 20.

To sum up, via the present invention, the user can ascertain the location of the smart phone and take related actions for decreasing lost risk according to the information received by the server device when the smart phone is lost.

Those skilled in the art will readily observe that numerous modifications and alterations of the device and method may be made while retaining the teachings of the invention.

What is claimed is:

1. A method for monitoring a smart phone comprising:
triggering a network connection function;
connecting to a server device via the network connection function to receive an indication signal indicating a lost status of the smart phone; and
returning information of the smart phone to the server device via the network connection function when the indication signal indicates that the smart phone is lost.

2. The method of claim 1, wherein triggering the network connection function is triggering the network connection function when a subscriber Identity Module card of the smart phone is replaced or removed.

3. The method of claim 1, wherein returning the information of the smart phone to the server device comprises:
triggering a global positioning function of the smart phone, to receive a location information; and
returning the location information to the server device.

4. The method of claim 1, wherein returning the information of the smart phone to the server device comprises:
triggering a camera function of the smart phone, to capture an image information; and
returning the image information to the server device.

5. The method of claim 1 further comprising stopping operations of the smart phone and generating an indication message asking for a password when the network connection function is incapable of being triggered for a predefined duration.

6. A system comprising:
a server device, for generating an indication signal according to a user message; and
a smart phone comprising:
an operating circuit, for executing functions of the smart phone; and
a monitoring device comprising:
a triggering unit, for triggering a network connection function of the operating circuit;
a connecting unit, for connecting to the server device, to receive the indication signal via the network connection function; and
a reporting unit, for returning information of the smart phone to the server device via the network connection function when the indication indicates that the smart phone is lost.

7. The system of claim 6, wherein the triggering unit triggers the network connection function when a Subscriber Identity Module card of the smart phone is replaced or removed.

8. The system of claim 6, wherein the operating circuit comprises a Global Positioning System (GPS) receiver for receiving a location information, and the reporting unit triggers the GPS receiver to return the location information to the server device, so as to return the information of the smart phone to the server device.

9. The system of claim 6, wherein the operating circuit comprises a camera for capturing an image information, and the reporting unit triggers the camera to return the image information to the sever device, so as to return the information of the smart phone to the server device.

10. The system of claim 6, wherein the monitoring device further comprises a lock unit, for stopping operations of the smart phone and generating an indication message asking for a password when the triggering unit is incapable of triggering the network connection function for a predefined duration.
